(19) United States
(12) Patent Application Publication
(10) Pub. No.: US 2021/0283711 A1
(43) Pub. Date: Sep. 16, 2021

(54) SHEET METAL BLANK AND ASSEMBLY WITH OXIDE REMOVAL ZONE

(71) Applicant: Grouper Blanking, LLC, Lexington, KY (US)

(72) Inventors: James J. Evangelista, Northville, MI (US); Michael Telenko, JR., Canton, MI (US); Ruth M. Sierra, Farmington Hills, MI (US)

(21) Appl. No.: 17/202,254

(22) Filed: Mar. 15, 2021

Related U.S. Application Data
(60) Provisional application No. 62/990,388, filed on Mar. 16, 2020.

(51) Int. Cl. B23K 20/12; C22C 21/06; B23K 26/36

(52) U.S. Cl. CPC B23K 20/122; B23K 2103/10; B23K 26/36; C22C 21/06

(57) ABSTRACT

A welded blank assembly includes aluminum-based sheet metal blanks joined by a friction stir weld and an oxide removal zone on a surface of at least one of the blanks. The average thickness of an oxide layer in the oxide removal zone is less than elsewhere along the surface. The weld is at least partially located in the oxide removal zone and is substantially free from oxide remnants. A method of making a welded blank assembly includes removing at least a portion of an oxide layer on an aluminum-based sheet metal blank to form the oxide removal zone, then joining the blanks together at the oxide removal zone with a weld. Oxide regrowth in the oxide removal zone can be minimized and/or inhibited by welding within a pre-determined time after oxide removal, control of the local environment between oxide removal and welding, and/or use of an oxide inhibitor.

### CROSS-REFERENCE TO RELATED APPLICATIONS

This application claims the benefit of U.S. provisional application Ser. No. 62/990,388 filed on Mar. 16, 2020, the contents of which is hereby incorporated by reference in its entirety.

### FIELD

The present disclosure relates to sheet metal blanks, welded blank assemblies, formed sheet metal components, and related methods, particularly with respect to aluminum-based sheet metal.

### BACKGROUND

Friction stir welding is a metal joining process useful for joining metals with relatively low melting points, such as aluminum alloys. Aluminum alloys are one family of materials commonly joined by friction stir welding in applications such as shipbuilding, aerospace, and train construction. These applications typically involve the joining of relatively thick plates of metal that are not subjected to post-weld forming processes. A tailor-welded blank meets neither of these criteria. Such a blank is produced for the very purpose of being formed into a three-dimensional shape after its individual sheet metal pieces are welded together. This poses new challenges for friction stir welding.

### SUMMARY

Embodiments of a welded blank assembly include a first aluminum-based sheet metal blank, a second aluminum-based sheet metal blank, an oxide layer formed on at least one surface of the first and/or second sheet metal blank, and an oxide removal zone located on the at least one surface of the first and/or second sheet metal blank. An average thickness of the oxide layer is less in the oxide removal zone than elsewhere on the at least one surface of the first or second sheet metal blank. The assembly includes a friction stir weld joining the first and second sheet metal blanks. The friction stir weld is at least partially located in the oxide removal zone and is substantially free from oxide remnants.

In some embodiments, the average thickness of the oxide layer in the oxide removal zone is 10 nanometers or less.

In various embodiments, at least one of the first or second sheet metal blanks has:
an aluminum-based alloy composition in which magnesium or zinc is present in an amount greater than any other non-aluminum element;
an aluminum-based alloy composition comprising magnesium in an amount greater than 2.8% by weight;
an aluminum-based alloy composition comprising zinc in an amount greater than 0.5% by weight;
an aluminum-based alloy composition comprising silicon in an amount greater than 0.8% by weight.

In some embodiments, the oxide layer has a first composition in the oxide removal zone and a second composition elsewhere on the at least one surface of the first or second sheet metal blank, an amount of non-aluminum oxide in the first composition is less than an amount of non-aluminum oxide in the second composition.

In some embodiments, at least one of the first or second sheet metal blanks comprises a base metal layer having an aluminum-based alloy composition comprising aluminum and at least one other non-aluminum element, an amount of the non-aluminum element is lower at an interface between the base metal layer and the oxide layer in the oxide removal zone than elsewhere within a thickness of the base metal layer.

In some embodiments, a formed sheet metal component is formed from the welded blank assembly and further comprises a bend along which or at which the friction stir weld has been plastically deformed.

Embodiments of an aluminum-based sheet metal blank for use in making a welded blank assembly include a base metal layer that has an aluminum-based alloy composition, an oxide layer that is formed on at least a portion of a first primary surface, on at least a portion of a second primary surface, and on at least a portion of a trimmed edge. The first and second primary surfaces are located on opposite sides of the sheet metal blank, and the trimmed edge extends between the first and second primary surfaces. The blank includes an oxide removal zone that is adjacent the trimmed edge and an interior region that is adjacent the oxide removal zone. The oxide layer has a first average thickness in the oxide removal zone and a second average thickness in the interior region, and the first average thickness is less than the second average thickness.

In some embodiments, the aluminum-based alloy composition comprises magnesium or zinc in an amount greater than any other non-aluminum element.

In some embodiments, the first average thickness is 10 nanometers or less.

In some embodiments, the oxide layer has a first composition in the oxide removal zone and a second composition in the interior region, an amount of non-aluminum oxide in the first composition is less than an amount of non-aluminum oxide in the second composition.

In some embodiments, the aluminum-based alloy composition comprises aluminum and at least one other non-aluminum element, an amount of the non-aluminum element is lower at an interface between the base metal layer and the oxide layer in the oxide removal zone than in the interior region.

In some embodiments, sheet metal blank further comprises an oxide inhibitor overlying the oxide removal zone. The oxide inhibitor may include a removable layer of material comprising an oil, a grease, a wax, a polymer, a peel-away film, or any combination thereof.

Embodiments of a method of making a welded blank assembly include providing a first aluminum-based sheet metal blank comprising an oxide layer formed on at least one surface with a reduced thickness at an oxide removal zone, providing a second aluminum-based sheet metal blank comprising an oxide layer formed on at least one surface with a reduced thickness at an oxide removal zone, and forming a friction stir weld joining the first and second sheet metal blanks together at the oxide removal zones, whereby the friction stir weld is substantially free from oxide remnants. The friction stir weld may also be substantially free from porosity, tunneling, wormholes, and other volumetric defects.

In some embodiments, the method includes plastically deforming the welded blank assembly at or along the friction stir weld after forming the friction stir weld to form a formed sheet metal component.

In some embodiments, the reduced thickness at each oxide removal zone is formed by removing at least a portion of the oxide layer at each oxide removal zone, and the method further comprises inhibiting oxide growth at each oxide removal zone between the step of removing the at least a portion of the oxide layer and the step of forming the friction stir weld.

In various embodiments, the step of inhibiting oxide growth comprises:
performing step (c) within a pre-determined amount of time after the step of removing;
disposing a layer of oxide-inhibiting material over the oxide removal zone of at least one of the first and second sheet metal blanks;
storing each sheet metal blank in an oxygen-depleted environment at least one oxide removal zone;
performing the step of removing in an oxygen-depleted environment;
performing step (c) in an oxygen-depleted environment;
feeding the first and second sheet metal blanks directly from an apparatus that performs the step of removing into a friction stir welder that performs step (c); or
any combination thereof.

In some embodiments, each sheet metal blank comprises a base metal layer having an aluminum-based alloy composition underlying the oxide layer, the reduced thickness at each oxide removal zone is formed by removing the oxide layer and a portion of the base metal layer at each oxide removal zone.

In some embodiments, the reduced thickness at each oxide removal zone is formed in a laser ablation process, the laser ablation process includes real-time analysis of a cleaning plume generated during ablation to help determine when a base metal layer of each sheet metal blank is reached.

It is contemplated that any one or more of the features listed above, illustrated in the drawings, or described below can be combined in any technically feasible combination to define a claimed invention.

### BRIEF DESCRIPTION OF THE DRAWINGS

FIG. 1 is a photomicrograph of a cross-section of a tailor-welded blank assembly, where the tailor-welded blank assembly is substantially free from oxide remnants in a weld;

FIG. 2 is a photomicrograph of a cross-section of a tailor-welded blank assembly, where the tailor-welded blank assembly includes oxide remnants in a weld;

FIG. 3 is an enlarged photomicrograph of a portion of the cross-section of the tailor-welded blank assembly in FIG. 2;

FIG. 4 is a schematic isometric view of a sheet metal blank prior to welding, where the sheet metal blank has an oxide removal zone;

FIG. 5 is a schematic cross-sectional view of the sheet metal blank of FIG. 4;

FIG. 6 is a schematic top view of a portion of the oxide removal zone of FIG. 4;

FIG. 7 is a schematic isometric view of an apparatus for forming an oxide removal zone by laser ablation;

FIG. 8 is a schematic cross-sectional view of another example of a sheet metal blank;

FIGS. 9-14 are schematic cross-sectional views of sheet metal blanks at various stages during a method of making a welded blank assembly, where the example method begins with FIG. 9 and ends with FIG. 14;

FIG. 15 is a schematic plan view of a welded blank assembly, where the welded blank assembly has a weld and is depicted before and after a metal forming operation; and

FIG. 16 is a schematic cross-sectional view of the weld of FIG. 15.

### DESCRIPTION

Described below is a welded blank assembly with newly defined criteria for a friction stir weld when an aluminum-based material is involved. In particular, oxide remnants have been identified as a problematic component of friction stir welds when part of a welded blank assembly intended for subsequent metal forming operations. It is known that an oxide layer will spontaneously form on surfaces of aluminum-based materials when exposed to the atmosphere. When joined to another metal piece by welding, material from the oxide layer can end up in the weld joint. This is particularly true with friction stir welding, in which there is no high-intensity laser, electrical arc, or open flame applied to the surface of the metal during welding that helps vaporize the oxide layer.

In conventional aluminum friction stir welding applications, oxide remnants have been considered somewhat harmless to weld integrity, with welding process parameters typically optimized to minimize or eliminate volumetric defects such as voids and wormholes along the weld. However, several factors have now been identified that cause the presence of surface oxides in a friction stir weld to be problematic. These factors are relatively specific to aluminum tailor-welded blanks, particularly in automotive applications where there are continuous efforts to improve fuel economy or otherwise conserve stored propulsion energy.

First, the sheet metal pieces being welded together are relatively thin compared with the metal plates of shipbuilding, for example. This makes the naturally formed oxide layer on aluminum-based materials a larger proportion of the overall thickness of the sheet metal, which volumetrically increases the amount of oxides that can end up in the weld. Second, a desire to use the thinnest aluminum-based materials possible tends to require the use of higher strength aluminum alloys with higher formability, such as alloys containing relatively large amounts of magnesium and/or silicon. This leads to a higher content of non-aluminum oxides in the oxide layer, such as oxides of magnesium, silicon, etc. Third, larger scale metal plates are not typically subjected to post-weld forming processes like tailor-welded blanks are. A friction stir welded blank assembly must survive subsequent metal forming processes.

In addition, residual stresses from such forming operations have been observed to cause a delayed fracture phenomenon in friction stir welds—i.e., cracks formed in the weld after several weeks or months that were not apparent when the weld was initially made and without any external stresses placed on the formed part. Such delayed weld fractures can occur even in friction stir welds that are made to current industry standards related to minimization of volumetric defects. Oxide remnants in the friction stir weld are believed to be at the root of the problem of delayed weld fractures. Additionally, volumetric defects in the friction stir weld are believed to more significantly contribute to delayed weld fractures when such defects are present in a friction stir weld that has been plastically deformed.

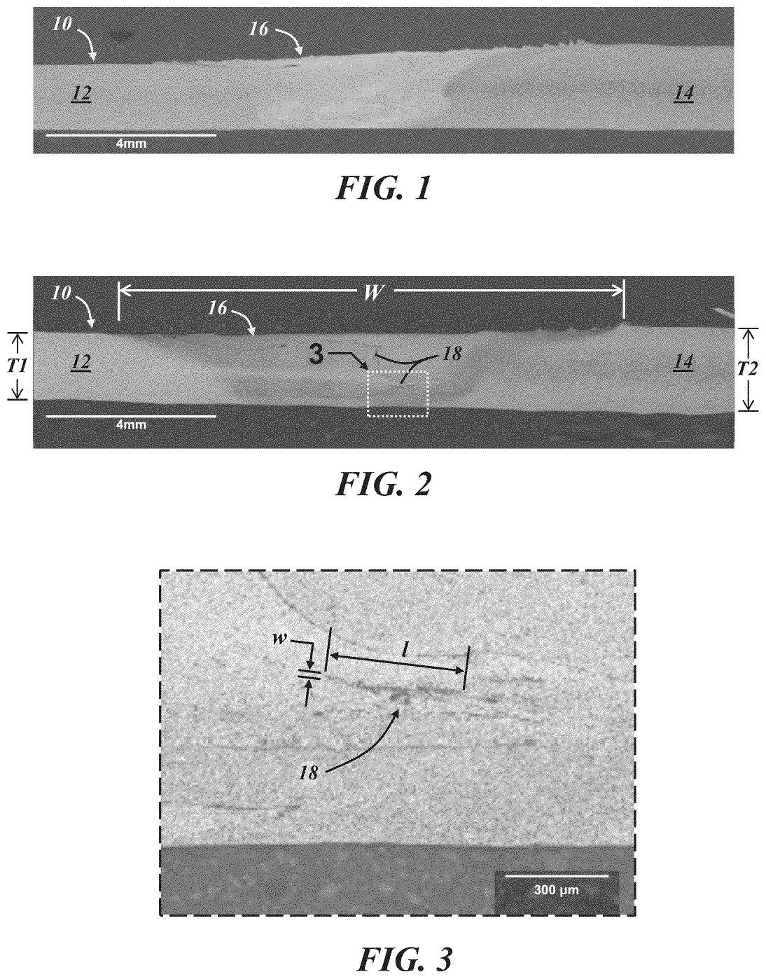

FIGS. 1 and 2 are photomicrographs of cross-sections of tailor-welded blank assemblies 10 at 50× magnification. Each blank assembly 10 includes a first aluminum-based sheet metal blank 12, a second aluminum-based sheet metal blank 14, and a friction stir weld 16 joining the first and second sheet metal blanks. The example of FIG. 2 includes oxide remnants 18 in the weld 16, while the example of FIG. 1 is substantially free from oxide remnants in the weld. As used herein, “substantially free from oxide remnants” means that the amount of oxide remnants 18 in the weld joint is 15 parts per million (ppm) or less. This represents a significant departure from allowable defects in automotive friction stir weld specifications, which permit weld inclusions ranging in size from 0.5 to 0.6 millimeters, which is equivalent to about 10,000 parts per million.

An oxide remnant 18 is a conglomeration of oxide compounds within the weld joint 16. These oxides may originate along surfaces and/or edges of the sheet metal pieces 12, 14 that were exposed to the atmosphere prior to welding. The oxides are essentially stirred into a friction stir weld. Additional oxidation of the metallic materials may occur during welding and additionally contribute to the presence of the oxide remnants. In a mounted, polished, and etched metallography cross-section taken through the weld joint 16, oxide remnants appear under 50× magnification as continuous dark lines or areas, as shown in FIG. 2. Other weld joint defects such as voids and other volumetric defects also appear as black lines or areas under the same magnification but can be differentiated as discussed below.

To be considered an oxide remnant 18 for purposes of this disclosure, the smallest dimension of a continuous black line or area in the etched metallographic cross-section must be at least 10 μm and the identified area must contain oxides, as determined by SEM-EDS analysis or similar. Mere voids and other volumetric defects will not contain measurable oxides. The presence of voids and other volumetric defects can be detected by other means, such as non-destructive ultrasound analysis.

To determine the concentration of oxide remnants 18 in the weld 16, the sum total cross-sectional area of the identified oxide remnants is measured and divided by the cross-sectional area of the weld. The area of the weld 16 is the width (W) at the top side of the weld multiplied by the average thickness of the base metal layers of the joined sheet metal blanks 12, 14. The width (W) is generally defined by the diameter of the shoulder of the friction stir welding tool.

FIG. 3 illustrates a portion of the friction stir weld 16 of FIG. 2 at 200× magnification and provides an example of an oxide remnant concentration calculation. The illustrated oxide remnant 18 has a length (l) of about 450 μm and a width (w) that varies from about 10 μm to about 50 μm along its length. The cross-sectional area of the identified remnant 18 is approximately 8500 μm². This can be determined manually or by digital image analysis of the micrograph. The cross-sectional area of the weld 16 of FIG. 2, which has a width of W=11.5 mm and an average thickness of 1.75 mm (T1=1.5 mm and T2=2.0 mm), is about 20.1 mm². This gives an oxide remnant concentration of about 0.042%, or 420 ppm. The identified oxide remnant 18 of FIG. 3 thus renders the weld 16 of FIG. 2 a weld that is not substantially free from oxide remnants, even if it is the only oxide remnant in the weld.

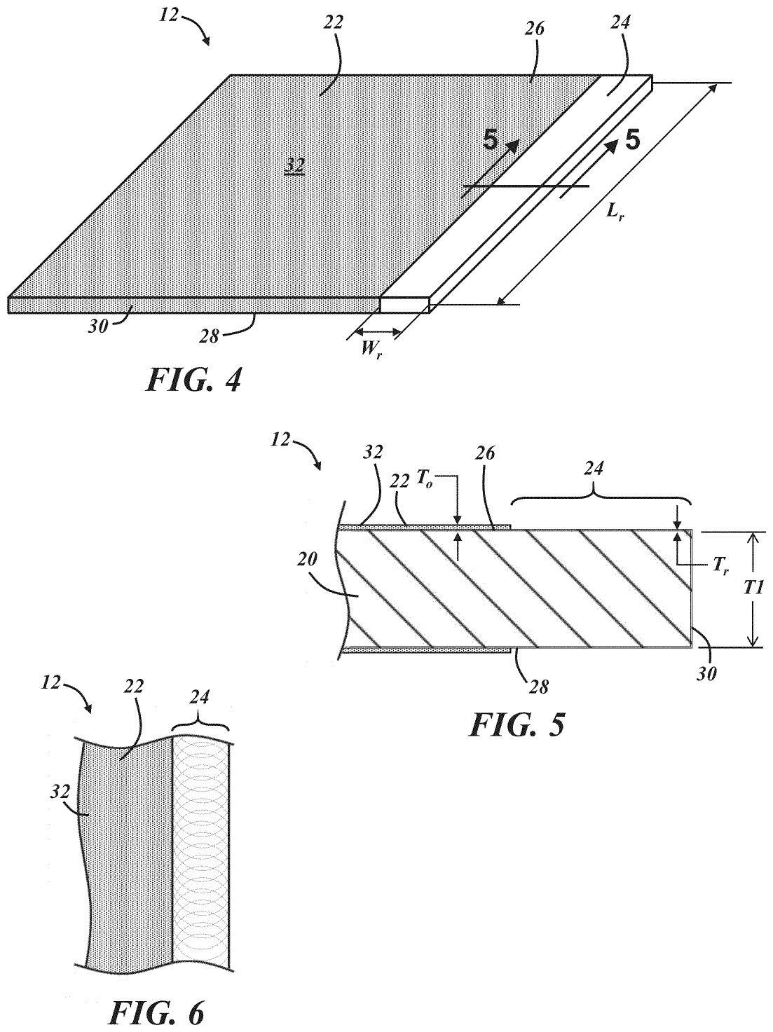

One way to ensure that the friction stir weld 16 is substantially free from oxide remnants is to minimize the thickness of the oxide layer at exposed surfaces of the aluminum-based sheet metal blanks, particularly at the intended location of the friction stir weld prior to welding. FIG. 4 schematically illustrates one of the sheet metal blanks 12 of a welded blank assembly prior to welding, and FIG. 5 is a cross-sectional view of a portion of the sheet metal blank of FIG. 4. The sheet metal blank 12 includes a base metal layer 20, an oxide layer 22, and an oxide removal zone 24. The base metal layer 20 has an aluminum-based alloy composition, and the oxide layer 22 is formed on at least a portion of at least one surface of the base metal layer. In this example, the oxide layer 22 is formed on a first primary surface 26, a second primary surface 28, and on a trimmed edge 30. The first and second primary surfaces 26, 28 are located on opposite sides of the sheet metal blank 12, and the trimmed edge 30 extends between the first and second primary surfaces along a periphery of the blank. The trimmed edge 30 is considered a surface, as used herein.

The oxide removal zone 24 is adjacent the trimmed edge 30, and an interior region 32 of the blank is defined adjacent the oxide removal zone. The oxide layer 22 has a first average thickness (Tᵣ) in the oxide removal zone 24 and a second average thickness (Tₒ) in the interior region 32, and the first average thickness is less than the second average thickness. In FIGS. 4 and 5, the thicker portion of the oxide layer 22 is depicted as a shaded region. The thickness (Tl) of the base metal layer 20 may be in a range from 0.5 mm to 3.0 mm or, more generally, 3.0 mm or less.

As used herein, an aluminum-based alloy composition is an alloy composition that includes aluminum as its single largest elemental constituent. In some embodiments, aluminum is a majority constituent of the composition, and in other embodiments aluminum is present in an amount greater than 90%, greater than 95%, or between 90% and 95% by weight. The base metal layer 20 may be wrought aluminum or a wrought aluminum alloy including one or more of the following elements in addition to aluminum: silicon, iron, copper, manganese, magnesium, chromium, nickel, zinc, titanium, silver, boron, bismuth, gallium, lithium, lead, tin vanadium, and zirconium. In some embodiments, the base metal layer 20 is a non-heat treatable aluminum alloy.

In more specific embodiments, the aluminum-based alloy composition is a 5000 series wrought aluminum alloy as designated by the International Alloy Designation System. The alloy composition may include magnesium as its largest non-aluminum elemental constituent. The aluminum-based alloy composition may for example include magnesium in an amount of at least 0.5% and up to 6% by weight. In some embodiments, magnesium is present in an amount of at least 2% by weight. In other embodiments, magnesium is present in an amount greater than 2.8%, such as in a range from 4% to 5% by weight.

In other specific embodiments, the aluminum-based alloy composition is a 6000 series wrought aluminum alloy as designated by the International Alloy Designation System and includes magnesium and silicon. The alloy composition may include silicon as its largest non-aluminum elemental constituent. Silicon may be present in an amount of at least 0.2% and up to 1.8% by weight, and magnesium may be present in the same alloy in an amount of at least 0.2% and up to 1.6% by weight, for example. In other embodiments, silicon and magnesium are each present in an amount of 0.5% or greater by weight, or in an amount from 0.5% to 1.5% by weight.

In other specific embodiments, the aluminum-based alloy composition is a 7000 series wrought aluminum alloy as designated by the International Alloy Designation System and includes magnesium and zinc. The alloy composition may include zinc as its largest non-aluminum elemental constituent. Zinc may be present in an amount of at least 0.8% and up to 12% by weight, for example. In some embodiments, zinc may present in an amount of at least 3% by weight. In other embodiments, zinc is present in an amount greater than 3%, such as in a range from 4% to 10% by weight.

The oxide layer 22 may be present at all exposed surfaces 26-30 of the sheet metal blank 12, with the thickness Tᵣ in the oxide removal zone 24 being less than the thickness Tₒ in the interior region. As discussed further below, the thickness of the oxide layer 22 is highly variable, as the layer may grow upon exposure to oxygen with growth typically slowing exponentially as the layer gets thicker. The growth rate, thickness, and distribution of the oxide layer 22 depends on many variables such as the material composition and surface grain orientation of the base metal layer 20, and the storage and handling of the material. The thickness of the oxide layer 22 may be in a range from 2 nm to about 100 μm, and a ratio between the thickness Tᵣ in the oxide removal zone 24 and the thickness Tₒ in the interior region 32 may increase over time until the two thicknesses are equal.

The oxide layer 22 may be naturally formed by exposure of the base metal layer 20 to atmospheric oxygen, or it may be intentionally formed in a more controlled manner, such as by anodizing or by heating the base material layer 20 in the presence of oxygen. In some cases, the oxide layer 22 may include a naturally formed portion in contact with the base metal layer 10 and an intentionally formed portion over the naturally formed portion. The oxide layer 22 has a composition that is a function of the material composition of the base metal layer 20. For example, while the oxide layer 22 on the aluminum-based alloy composition may include aluminum oxide, other oxides such as oxides of magnesium, silicon, zinc, chromium, and/or other elemental constituents may also be present.

The oxide removal zone 24 is a portion of the sheet metal blank 12 along which the oxide layer 22 has been removed or otherwise had its thickness reduced. In the illustrated example, the sheet metal blank 12 has been prepared for welding to another metal piece by forming the oxide removal zone 24 along the trimmed edge 30. In particular, at least a portion of the oxide layer 22 has been removed from an area having a width Wᵣ and a length Lᵣ at both of the first and second primary surfaces 26, 28. At least a portion of the oxide layer 22 has also been removed from the trimmed edge 30 along the entire length Lᵣ of one side of the rectangular periphery of the blank 12 and from portions of the trimmed edge extending in the direction of the width Wᵣ on two other sides of the periphery of the blank. It is noted that layer thicknesses are not necessarily to scale in the figures.

The width Wᵣ of the oxide removal zone 24 may be made to accommodate the size of the weld to be formed. For example, in the case of a butt weld formed by friction stir welding, the width Wᵣ may be one half of the diameter of the shoulder of the friction stir welding tool or greater. For a friction stir weld using a welding tool with a 12 mm shoulder, for example, the width Wᵣ of the oxide removal zone may be greater than 6 mm. This is not always the case, however, as a friction stir weld can be made non-symmetric with respect to the edges of the sheet metal blanks that are butted together. Also, when a butt weld is formed by friction stir welding sheet metal blanks of different thicknesses, the tool may be oriented non-parallel with the primary surfaces of the blanks such that the width of the finished weld is less than the full diameter of the welding tool. Preferably, the width Wᵣ of the oxide removal zone 24 on each blank to be welded provides 0.5 mm or more of the oxide removal zone on each of the opposite sides of the finished weld.

The oxide removal zone 24 may be formed by various methods, including but not limited to laser ablation, chemical treatment, plasma treatment, or mechanical abrasion of the oxide layer 22 wherever the oxide removal zone is desired—i.e., wherever the friction stir weld is to be formed. In addition to having an oxide layer thickness Tᵣ less than that of the interior region, the oxide removal zone 24 may have other identifying characteristics, some of which are dependent upon the oxide removal method. For example, the surfaces of the sheet metal blank 12 in the oxide removal zone 24 may have a higher reflectivity than the surfaces in the interior region 32. Qualitatively, this means that the surface in the oxide removal zone 24 may appear shinier than the other areas of the sheet metal blank 12. Quantitatively, this means that a higher percentage of visible light is reflected in a direction normal to the surface in the oxide removal zone 24 than in the other areas of the sheet metal blank as measured with a reflectometer. This is due to a higher portion of incident light being scattered and/or absorbed by thicker portions of the oxide layer 22. This reflectivity differential may be most apparent with chemical removal or laser ablation. In some cases, the reflectivity of surfaces in the oxide removal zone 24 is merely different from the reflectivity of surfaces in the interior region 32. For example, an angle of highest reflectivity of visible light may be different at the oxide removal zone 24 than at the interior region 32.

The oxide removal zone 24 may have a laser ablated appearance, as depicted schematically in FIG. 6, which is a top view of a portion of the oxide removal zone 24. In this example, laser ablation of the oxide layer 22 has been performed in the lengthwise direction of the oxide removal zone 24 using a high frequency pulsed laser. Due to factors such as a non-uniform power distribution across the diameter of the laser beam and overlapping sequential laser pulses causing different subregions of the ablated area to be exposed to different numbers of laser pulses, an ablation fingerprint may be apparent on close visual examination of the oxide removal zone or under a microscope. While the ablated surface may feel smooth or even be measured to have a low roughness value, nanometer-scale differences in the ablation pattern may be visibly noticeable due to the regularity of the ablation pattern and the different angles of reflectivity of light at different locations within each individual laser pulse location.

Oxide layer removal by mechanical abrasion may impart the oxide removal zone 24 with a different visible character such as lines of abrasion formed in the direction of abrasion or an average surface roughness higher than that of the interior region 32, particularly as measured in a direction normal to the direction of abrasion. Although reflectivity of visible light may not necessarily be higher in the oxide removal zone 24 in a direction normal to the surface of the sheet metal blank, a characteristic reflectivity measured as a function of angle of reflection may be different from that of the interior region.

Formation of the oxide removal zone 24 by chemical treatment may include the use of chemicals in which one or more components of the oxide layer 22 are soluble and/or chemicals with which one or more components of the oxide layer will react (e.g., a reduction reaction). As such, the type of chemical treatment may be dependent upon the aluminum-based alloy composition and the oxide layer composition. One example of a chemical treatment that can be used to remove a portion of the oxide layer 22 to form the oxide removal zone 24 is a deoxidizing agent including a mixture of ferrous salts (e.g., ferrous sulfate) and acid (e.g., nitric acid). One such mixture is available under the tradename Oakite® LNC (Chemetall US, Inc., New Providence, N.J.). In another example, oxide removal includes treatment with a solution comprising a strong acid, such as hydrofluoric acid, hydrochloric acid, or sulfuric acid. Oxides of zinc and magnesium are soluble in most acids, and some acids will react with oxides of aluminum and silicon to break down the oxide into water soluble components. Hydrofluoric acid may be particularly useful on oxides of aluminum-based alloy compositions having a high silicon content. Other chemical treatments may include the use of alkali treatments (e.g., NaOH) or ammonia. Ammonia may be particularly useful on oxides of aluminum-based alloy compositions having a high magnesium content. Chemical treatments can be combined with other oxide removal techniques, such as being performed before and/or after laser ablation.

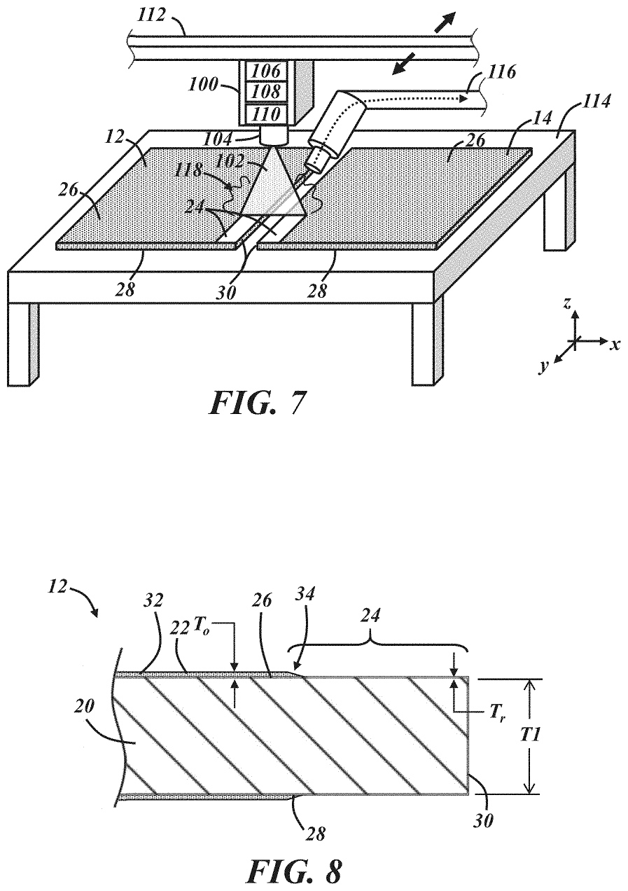

FIG. 7 illustrates an apparatus and method of forming the oxide removal zone 24 by laser ablation. The closed-loop monitoring aspect of this method can help to more precisely control heat conduction in order to prevent adverse effects to the base metal layer 20. While the following method is described in the context of preparing two aluminum-based sheet metal blanks 12, 14 at the same time, a similar technique can be used to form the oxide removal zone 24 on one blank at a time, or on continuous aluminum-based sheet material before cut into smaller blanks.

The method involves directing a removal apparatus 100 toward the desired location of the oxide removal zone 24 of each sheet metal blank 12, 14. In this example, the sheet metal blanks 12, 14 are aligned such that their respective trimmed edges 30 face each other in the orientation in which they will eventually be joined by welding. The removal apparatus 100 uses a scanning beam 102 from a laser source 104, which may include a beam generator and one or more optics (e.g., lenses or mirrors) arranged to deliver the beam to the sheet metal blanks 12, 14. The removal apparatus 100 may further include a scan controller 106, processor 108, and memory 110. The scan controller 106 can adjust the dimensions and various other properties of the scanning beam 102 during the oxide removal process. For example, the scan controller 106 can control the shape and/or direction of the beam 102 within an X-Y-Z coordinate system. With a 3D scanner, the first primary surface 26 and the trimmed edge 30 of each sheet metal blank 12, 14 can be treated in one pass. The area of coverage with a 2D scan (x-y) may be in a range from about 200×200 mm to about 400×400 mm, and the volume of coverage of a 3D scan (x-y-z) may be in a range from about 200×200×50 mm to about 400×400×150 mm. These beam sizes can provide for oxide removal from sheet metal blanks 12, 14 even when spaced apart as shown.

The controller 106 can be configured to adjust various operating parameters of the laser source 104 and/or beam 102, such as the power, pulse duration, wavelength, pulse frequency, and the location and/or movement speed of the laser source (e.g., movement of a gantry 112 movably supporting the removal apparatus). The memory 110 may store information related to the intended scan area, laser parameters, threshold values for process parameters, and/or process information specific to each individual oxide removal cycle, for example.

The laser source 104 may have an average power in a range from 10 W to 5000 W, such as an 800 W laser, and may provide an ultra-fast pulsed laser (e.g., a nanosecond, picosecond, or femtosecond pulsed laser). A nanosecond pulsed laser may for example provide a laser pulse duration in a range from 1 ns to 100 ns, such as 25 ns. The wavelength of the laser may be in a range from 850 nm to 1200 nm, such as 1030 nm. Laser pulse frequency may be in a range from 5 kHz to 100 kHz, such as 30 kHz. The linear speed of the gantry 112 with respect to the blanks 12, 14 may be in a range from 1 m/min to 25 m/min, such as about 6 m/min. These process parameters are of course non-limiting.

In this example, separate portions of the beam 102 are symmetrically directed at the separate sheet metal blanks 12, 14 at their respective oxide removal zones 24. A second laser or removal apparatus can be simultaneously directed toward the second primary surface 28 of each blank 12, 14 from the underside or via additional laser optics. Movement of the removal apparatus 100 relative to the blanks 12, 14 is accomplished via movement of the gantry 112, a robot, or other movement mechanism while the sheet metal blanks 12, 14 are held stationary on a base 114. The oxide layer 22 in the oxide removal zone 24 is vaporized during ablation and transported away by a separation system 116.

The apparatus 100 may be equipped to monitor oxide removal and adjust process parameters in real-time. For example, the pulsed laser beam 102 creates a cleaning plume 118 which can be analyzed in real-time using a visual, laser, or plasma-based inspection system. The cleaning plume 118 may be analyzed using laser induced breakdown spectroscopy (LIBS) in which one or more pulses from the beam 102 remove a portion of the oxide layer 22 and also generate an atomic emission from the ablated particles. A LIBS spectrum or spectra can provide relative concentrations of different constituents in the plume 118. This information can then be used to adjust process parameters. For example, when the entire thickness of the oxide layer 22 is removed, a sudden increase in the amount of aluminum or other elemental constituent relative to the amount of oxygen can be detected in the LIBS spectrum. Using this information, laser pulses can be delivered to the same location until the base metal layer is reached before the laser beam 102 moves on to a new location for further oxide removal. Other elemental constituents can be monitored and used as indicators for process changes.

The oxide layer 22 may be completely removed to expose the surface of the base metal layer 20 in the oxide removal zone 24. This exposed surface may only briefly or momentarily be exposed, as a new 2-4 nm oxide layer forms on the exposed base metal layer almost instantly with aluminum-based alloy compositions. Accordingly, a method of making a welded blank assembly 10 may include taking one or more steps to inhibit oxide growth in the oxide removal zone 24 of individual sheet metal blanks 12, 14 during the time between formation of the oxide removal zone and welding one sheet metal blank to another.

In one embodiment, inhibiting oxide growth after forming the oxide removal zone 24 includes limiting an amount of time between the step of forming the oxide removal zone and the step of welding. For example, the blanks 12, 14 may be welded together as soon as possible after the oxide removal zone 24 is formed to achieve a weld joint that is substantially free from oxide remnants. In different embodiments, the friction stir weld is formed within 1 minute, within 30 minutes, within 60 minutes, within 2 hours, within 24 hours, within 48 hours, or within 72 hours from creation of the oxide removal zone. This time may vary due to the variability of oxide layer growth rates based on the specific environment and material composition of the base metal layer, for example. Welding may be performed within a pre-determined amount of time after formation of the oxide removal zone. The pre-determined time can be arrived at experimentally by incrementally increasing the time until the above-described weld inspection reveals an unacceptable amount of oxide remnants. The pre-determined time is then set to a time that is less than the time after which unacceptable oxide remnants appeared in the weld. In another embodiment, the weld may be formed before the thickness of the oxide layer in the oxide removal zone exceeds 10 nm.

In some embodiments, inhibiting oxide growth includes performing the oxide removal process in conjunction with or contemporaneously with the friction stir welding process to form the welded blank assembly. For example, the sheet metal blanks 12, 14 with their newly formed oxide removal zones 24 can be fed directly into the friction stir welding operation from the oxide removal apparatus to minimize exposure of the oxide removal zones to the atmosphere. Such a process can reduce the elapsed time between oxide removal and welding to only a few seconds—e.g., in a range from 1 second to 30 seconds.

In another example, inhibiting oxide growth includes maintaining the sheet metal blanks in an oxygen-free or oxygen depleted environment after oxide removal and before welding. This can take multiple forms at multiple stages of the overall process and can serve to extend the permissible time between oxide removal and welding. For example, oxide removal can be performed in the presence of a shield gas (e.g., nitrogen or a noble gas) in the oxide removal zone 24 and/or in a room or chamber with an oxygen depleted environment. From there, the blanks 12, 14 can be fed directly to the friction stir welding operation or stored and/or transported in an oxygen-depleted environment. The friction stir welding operation may also be performed in an oxygen-depleted environment or while directing a shield gas along the area of weld formation. As used herein, an oxygen-depleted environment is an environment in which the concentration of oxygen is lower than atmospheric oxygen, or less than about 20%. Examples of oxygen-depleted environments include environments with less than 10%, less than 5%, less than 1%, or less than 0.1% oxygen. In one embodiment, the oxygen-depleted environment is a liquid environment, where the liquid is a non-oxidizing material. A flux compound can also or alternatively be used to inhibit oxide growth during the step of welding.

In another example, inhibiting oxide growth includes use of an oxide inhibitor between oxide removal and welding. For example, a protective coating can be disposed over the oxide removal zone 24 immediately after its formation, or at least before the sheet metal blank is exposed to an oxygen-containing atmosphere. Such a coating should be one that is easily removed prior to welding or one that vaporizes at the temperatures generated during the welding operation. A removable oxide inhibitor may be a coating that is not covalently or otherwise permanently bonded to the underlying material. One example of a removable protective coating is an oil immersion or a thin layer of oil, which can be later removed with a detergent or organic solvent. A layer of grease, wax, vinyl, or other polymer film or material is another example. Or the sheet metal blank can be laminated between layers of a polymeric film that can be peeled away prior to welding.

FIG. 8 is a cross-sectional view of a portion of a sheet metal blank 12 similar to that of FIG. 5. In this example, the oxide removal zone 24 has been formed by laser ablation such that the thickness Tᵣ of the oxide layer in the oxide removal zone is non-uniform. In particular, the oxide removal zone 24 includes a transition portion 34 where only a portion of the thickness of the oxide layer 22 has been removed. The transition portion 34 lies along a boundary between the oxide removal zone 24 and the interior region 32 and has a thickness Tₒ equal to that of the interior region 32 on one side and a thickness Tᵣ equal to that of the remainder of the oxide removal zone 24 on an opposite side. Such a transition portion 34 can be formed with a laser beam having a gaussian or other non-uniform power distribution across its width. The transition portion 34 can reduce the presence of a stress-riser at the boundary between the oxide removal zone 24 and the interior region 32, which can be useful with welded blank assemblies that are to undergo subsequent metal forming operations.

In some embodiments, the oxide layer 22 has a first composition in the oxide removal zone 24 and a different second composition in the interior region 32. For instance, the oxide layer 22 may include oxides of aluminum at both the oxide removal zone 24 and the interior region 32 but may include a relatively smaller amount of non-aluminum oxides at the oxide removal zone. This phenomenon may occur due to the faster kinetics of aluminum oxidation in comparison to that of non-aluminum elements. In other words, some of the non-aluminum elements of the underlying alloy may not oxidize as quickly as the aluminum. As noted above, a 2-4 nm layer of aluminum oxide may form on the aluminum-based alloy of the sheet metal almost instantly after full removal of the oxide layer in the oxide removal zone. At least at that time, the oxide layer 22 has a composition in the oxide removal zone with a higher aluminum oxide content than the oxide layer composition in the interior region 32. Moreover, some of the non-aluminum oxides are slower to form and/or require higher temperatures to form at all, such as during the initial production of the alloy itself. Non-aluminum oxides are believed to be particularly problematic in causing unacceptable amounts of oxide remnants in friction stir welds. In one aspect, formation of the oxide removal zone thus includes reducing the non-aluminum oxide content of the oxide layer at the intended weld location.

Another step that may be taken to slow non-aluminum oxide regrowth in the oxide removal zone is to form an aluminum-rich surface during oxide removal. For example, in the subsequently described example of a laser ablation process, ablation can continue once the underlying aluminum-based alloy is reached. Due to differences in vaporization points of the elements of the alloy, certain elements may be preferentially removed from the alloy at oxide-free surface. For example, any free magnesium or zinc in the alloy may vaporize while free aluminum is not. In one embodiment, the laser ablation process can adapt in real time to change one or more process parameters once it detects that the oxide layer is removed at the oxide removal zone to preferentially vaporize constituents such as magnesium and zinc to form an aluminum-rich surface in the oxide removal zone. After a thin 2-4 nm layer of aluminum oxide immediately reforms at the oxide removal zone, the composition of the underlying alloy is different at the oxide interface than elsewhere within the thickness of the base metal layer.

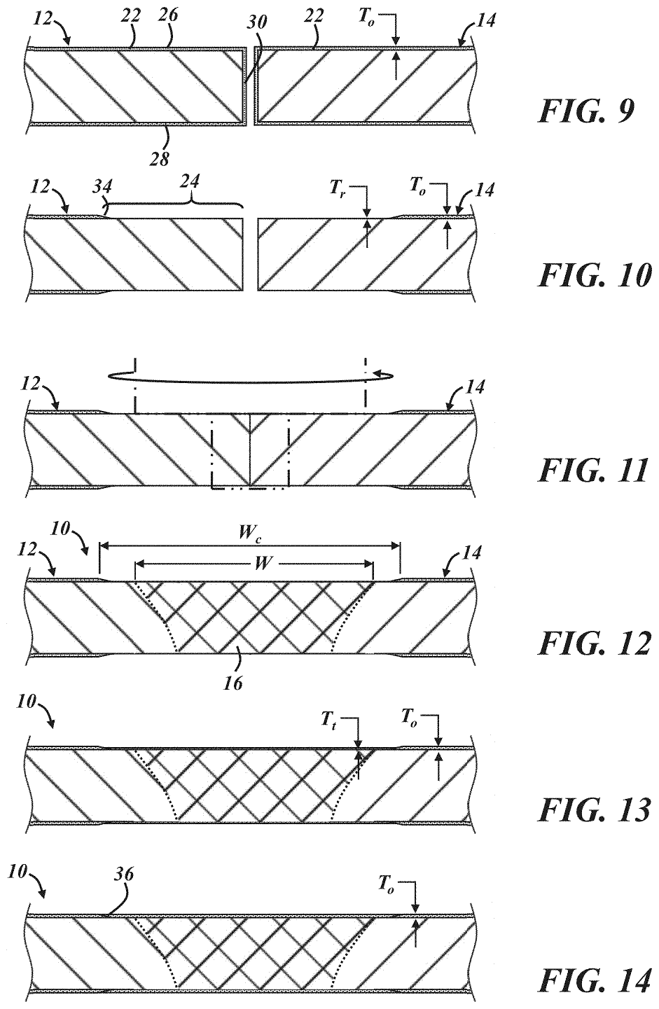

FIGS. 9-14 illustrate sheet metal blanks 12, 14 at various stages during an exemplary method of making a welded blank assembly 10. The method begins with providing the first and second aluminum-based sheet metal blanks 12, 14 each with a respective oxide layer 22 formed on at least one surface as in FIG. 9. In this case, the oxide layers 22 are formed at all exposed surfaces 26-30 of each blank 12, 14 and have a thickness of Tₒ, although the oxide layer thickness may be different on one surface, such as the trimmed edge, than on another surface.

The oxide removal zone 24 is then formed on each sheet metal blank 12, 14 as described above and depicted in FIG. 10. The oxide layer 22 has a reduced average thickness Tₒ in the oxide removal zone 24 and may include a transition portion 34 having a thickness between Tᵣ and Tₒ.

Opposing edges 30 of the sheet metal blanks 12, 14 are then abutted as in FIG. 11, and a friction stir weld 16 is formed to join the sheet metal blanks together as shown in FIG. 12 to thereby form the welded blank assembly 10. The friction stir weld 16 is at least partially located in the oxide removal zone 24 of at least one of the sheet metal blanks 12, 14. By virtue of the oxide removal zone(s), the friction stir weld 16 may be substantially free from oxide remnants. In this case, the entire weld 16 is located in a combined oxide removal zone defined by the oxide removal zone 24 of the first sheet metal blank 12 together with the oxide removal zone 24 of the second sheet metal blank 14. A width W_{c} of the combined oxide removal zone is greater than the width W of the weld 16 such that a portion of the oxide removal zone 24 of each blank 12, 14 is exposed alongside the weld 16. This exposed portion of the oxide removal zones 24 may have one or more of the characteristics described above (e.g., increased reflectivity, laser ablated appearance, etc.) after the weld 16 is formed.

FIGS. 13 and 14 depicted continued growth of the oxide layer 22 after the weld 16 and blank assembly 10 are made. Due to the smaller thickness of the oxide layer 22 in the oxide removal zones 24 of each blank 12, 14 and, consequently, over the weld 16 and the relatively greater thickness of the oxide layer away from the weld immediately after weld formation, oxide growth is initially faster in the oxide removal zone. FIG. 13 depicts the welded blank assembly with the oxide layer 22 having a transitional thickness Tₜ greater than the oxide layer thickness Tᵣ of the sheet metal blanks 12, 14 just prior to welding, but less than the oxide layer thickness Tₒ away from the oxide removal zones. Because oxide layer growth slows exponentially with thickness, the oxide layer 22 of the finished welded blank assembly 10 may eventually become generally uniform over all of the surfaces of the welded blank assembly, including over the weld and over the former oxide removal zones. An oxide layer boundary 36 may be apparent via examination of metallography samples even after that oxide layer thickness becomes uniform across the weld due to the directional constraints on oxide layer growth next to an already existing oxide layer at that boundary.

While FIGS. 9-14 illustrate the first and second sheet metal blanks 12, 14 as having the same base metal layer thickness, it should be appreciated that the welded blank assembly 10 can be made with the blanks having different thicknesses. It should also be appreciated that, although oxide remnants and their exclusion from friction stir welds described above is somewhat specific to aluminum-based alloy compositions, each sheet metal blank 12, 14 may have a base metal layer with a material composition that is different from the other. For example, the first sheet metal blank 12 may have a base metal layer with a composition defined as a 2000 series wrought aluminum alloy, and the second sheet metal blank 14 may have a base metal layer with a composition defined as a 5000 series wrought aluminum alloy. In some cases, one of the sheet metal blanks may have a base metal layer that is not an aluminum-based alloy.

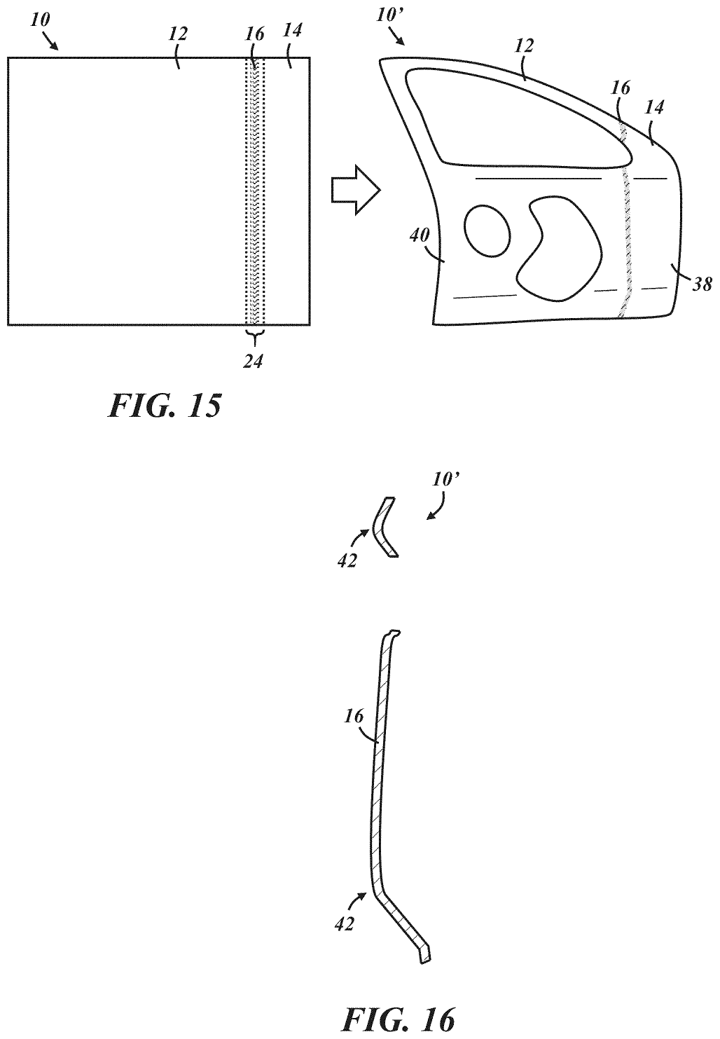

Tailor-welded blanks may include a first sheet metal blank welded to a second sheet metal blank of the same thickness, as in FIGS. 9-14, or the first sheet metal blank may have a different thickness and/or a base metal layer material composition than that of the second sheet metal blank. An example of a tailor-welded blank assembly 10 is provided in FIGS. 15 and 16.

FIG. 15 is a plan view of a welded blank assembly 10 depicted before and after a metal forming operation in which the blank assembly is changed from a generally flat sheet form to a formed and trimmed blank assembly 10′ with a three-dimensional contour. In this non-limiting example, the formed blank assembly 10′ is the inner panel of a vehicle door with a hinge side 38 and a latch side 40. The first and second sheet metal blanks 12, 14 of the blank assembly 10 are joined by a friction stir weld 16 along an oxide removal zone 24 in accordance with the above description. In this case, the second sheet metal 14 blank may have a greater thickness than the first sheet metal blank 12 and/or the second sheet metal blank may be made from a material having a higher strength than that of the first sheet metal blank, due to the higher load bearing requirements on the hinge side 38 of the vehicle door panel 10′ being formed.

FIG. 16 is a cross-sectional view along the lengthwise direction of the weld 16, illustrating an exemplary three-dimensional contour of the formed blank assembly 10′. In this manner, the welded blank assembly 10 becomes part of a formed sheet metal component 10′ with one or more bends 42 along which or at which the friction stir weld has been plastically deformed. Forming the weld 16 in accordance with the above description to exclude oxide remnants from the weld can improve long-term weld integrity and reduce or eliminate the delayed fracture phenomenon in plastically deformed weld joints which may have residual stresses formed into them.

While the examples above are presented in the context of first and second sheet metal blanks being friction stir welded together in an edge-to-edge butt joint configuration, other friction stir weld joints are possible, including an L-butt joint, a T-butt joint, a lap joint, or a fillet joint. In each case, the weld can be formed to be substantially free of oxide remnants by forming and locating the weld at least partially in an oxide removal zone of one or both of the blanks being welded together.

It is to be understood that the foregoing description is not a definition of the invention, but is a description of one or more exemplary illustrations of the invention. The invention is not limited to the particular example(s) disclosed herein, but rather is defined solely by the claims below. Furthermore, the statements contained in the foregoing description relate to particular exemplary illustrations and are not to be construed as limitations on the scope of the invention or on the definition of terms used in the claims, except where a term or phrase is expressly defined above. Various other examples and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A welded blank assembly, comprising:
a first aluminum-based sheet metal blank;
a second aluminum-based sheet metal blank, an oxide layer formed on at least one surface of the first or second sheet metal blank;
an oxide removal zone located on the at least one surface of the first or second sheet metal blank, an average thickness of the oxide layer is less in the oxide removal zone than elsewhere on the at least one surface of the first or second sheet metal blank; and
a friction stir weld joining the first and second sheet metal blanks, wherein the friction stir weld is at least partially located in the oxide removal zone and is substantially free from oxide remnants.

2. The welded blank assembly of claim 1, wherein at least one of the first or second sheet metal blanks has an aluminum-based alloy composition in which magnesium or zinc is present in an amount greater than any other non-aluminum element.

3. The welded blank assembly of claim 1, wherein at least one of the first or second sheet metal blanks has an aluminum-based alloy composition comprising magnesium in an amount greater than 2.8% by weight.

4. The welded blank assembly of claim 1, wherein at least one of the first or second sheet metal blanks has an aluminum-based alloy composition comprising zinc in an amount greater than 0.5% by weight.

5. The welded blank assembly of claim 1, wherein at least one of the first or second sheet metal blanks has an aluminum-based alloy composition comprising silicon in an amount greater than 0.8% by weight.

6. The welded blank assembly of claim 1, wherein the average thickness of the oxide layer in the oxide removal zone is 10 nanometers or less.

7. The welded blank assembly of claim 1, wherein the oxide layer has a first composition in the oxide removal zone and a second composition elsewhere on the at least one surface of the first or second sheet metal blank, an amount of non-aluminum oxide in the first composition is less than an amount of non-aluminum oxide in the second composition.

8. The welded blank assembly of claim 1, wherein at least one of the first or second sheet metal blanks comprises a base metal layer having an aluminum-based alloy composition comprising aluminum and at least one other non-aluminum element, an amount of the non-aluminum element is lower at an interface between the base metal layer and the oxide layer in the oxide removal zone than elsewhere within a thickness of the base metal layer.

9. A formed sheet metal component, comprising the welded blank assembly of claim 1, the formed sheet metal component further comprising a bend along which or at which the friction stir weld has been plastically deformed.

10. An aluminum-based sheet metal blank, comprising:
a base metal layer that has an aluminum-based alloy composition;
an oxide layer that is formed on at least a portion of a first primary surface, on at least a portion of a second primary surface, and on at least a portion of a trimmed edge, the first and second primary surfaces are located on opposite sides of the sheet metal blank, and the trimmed edge extends between the first and second primary surfaces;
an oxide removal zone that is adjacent the trimmed edge; and
an interior region that is adjacent the oxide removal zone, wherein the oxide layer has a first average thickness in the oxide removal zone and a second average thickness in the interior region, and the first average thickness is less than the second average thickness.

11. The aluminum-based sheet metal blank of claim 10, wherein the aluminum-based alloy composition comprises magnesium or zinc in an amount greater than any other non-aluminum element.

12. The aluminum-based sheet metal blank of claim 10, wherein the first average thickness is 10 nanometers or less.

13. The aluminum-based sheet metal blank of claim 10, wherein the oxide layer has a first composition in the oxide removal zone and a second composition in the interior region, an amount of non-aluminum oxide in the first composition is less than an amount of non-aluminum oxide in the second composition.

14. The aluminum-based sheet metal blank of claim 10, wherein the aluminum-based alloy composition comprises aluminum and at least one other non-aluminum element, an amount of the non-aluminum element is lower at an interface between the base metal layer and the oxide layer in the oxide removal zone than in the interior region.

15. The aluminum-based sheet metal blank of claim 10, further comprising an oxide inhibitor overlying the oxide removal zone.

16. The aluminum-based sheet metal blank of claim 15, wherein the oxide inhibitor is a removable layer of material comprising an oil, a grease, a wax, a polymer, a peel-away film, or any combination thereof.

17. A method of making a welded blank assembly, comprising:
(a) providing a first aluminum-based sheet metal blank comprising an oxide layer formed on at least one surface with a reduced thickness at an oxide removal zone;
(b) providing a second aluminum-based sheet metal blank comprising an oxide layer formed on at least one surface with a reduced thickness at an oxide removal zone; and
(c) forming a friction stir weld joining the first and second sheet metal blanks together at the oxide removal zones, whereby the friction stir weld is substantially free from oxide remnants.

18. The method of claim 17, further comprising the step of plastically deforming the welded blank assembly at or along the friction stir weld after step (c) to form a formed sheet metal component.

19. The method of claim 17, wherein the reduced thickness at each oxide removal zone is formed by removing at least a portion of the oxide layer at each oxide removal zone, the method further comprising the step of inhibiting oxide growth at each oxide removal zone between the step of removing the at least a portion of the oxide layer and step (c).

20. The method of claim 19, wherein the step of inhibiting oxide growth comprises:
performing step (c) within a pre-determined amount of time after the step of removing;
disposing a layer of oxide-inhibiting material over the oxide removal zone of at least one of the first and second sheet metal blanks;
storing each sheet metal blank in an oxygen-depleted environment at least one oxide removal zone;
performing the step of removing in an oxygen-depleted environment;
performing step (c) in an oxygen-depleted environment;
feeding the first and second sheet metal blanks directly from an apparatus that performs the step of removing into a friction stir welder that performs step (c); or
any combination thereof.

21. The method of claim 17, wherein each sheet metal blank comprises a base metal layer having an aluminum-based alloy composition underlying the oxide layer, the reduced thickness at each oxide removal zone is formed by removing the oxide layer and a portion of the base metal layer at each oxide removal zone.

22. The method of claim 17, wherein the reduced thickness at each oxide removal zone is formed in a laser ablation process, the laser ablation process includes real-time analysis of a cleaning plume generated during ablation to help determine when a base metal layer of each sheet metal blank is reached.
